(19) United States
(12) Patent Application Publication
(10) Pub. No.: US 2013/0295457 A1
(43) Pub. Date: Nov. 7, 2013

(54) Composite Anodes with an Interfacial Film

(71) Applicant: WANLI XU, BATON ROUGE, LA (US)

(72) Inventor: WANLI XU, BATON ROUGE, LA (US)

(73) Assignee: ELECTROCHEMICAL MATERIALS, BATON ROUGE, LA (US)

(21) Appl. No.: 13/939,583

(22) Filed: Jul. 11, 2013

Related U.S. Application Data
(63) Continuation-in-part of application No. 13/363,587, filed on Feb. 1, 2012.

(51) Int. Cl. H01M 4/36; H01M 4/62

(52) U.S. Cl. CPC H01M 4/366; H01M 4/622
USPC 429/211

(57) ABSTRACT

A composite anode for lithium secondary battery, which has an active anode material layer formed on a conductive substrate and an interfacial film coated on the active anode material layer, wherein the active anode material layer includes carbonaceous materials, other active and inactive materials, and a binder. The anode increases degree of the anode active material utilization and the cycle life and characteristic and capacity of the battery can be improved.

### CROSS-REFERENCE TO RELATED APPLICATIONS

This application is continuation in part of U.S. patent application Ser. No. 13/363,587

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to a composite anode having an interfacial film and a lithium secondary battery employing the anode, and more particularly, to an anode having an interfacial film coated thereon and a lithium secondary battery employing the anode, which has improved cycle life and battery capacity characteristics.

2. Description of the Related Art

Rapid development of portable electronic devices and electrical vehicles has led to an increasing demand for lighter, smaller secondary batteries with high energy and powder density. Among the currently developing batteries satisfying such requirements, lithium ion battery is one of the most promising batteries in view of its relatively high energy and power density.

As such a secondary battery, there has been proposed various lithium ion batteries. In these batteries, a carbonaceous anode material has been adopted conventionally, such as graphite which is capable of intercalating and disintercalating lithium ions reversibly for lithium storage. Many of these batteries have been developed and commercialized. Among these batteries, however, theoretical maximal lithium can be intercalated in carbon is limited to 1 lithium atom per 6 carbon atoms, which is equivalent to a theoretical maximal capacity of 378 mAh/g. Further, mechanical failure has been commonly observed for graphite anodes after prolonged cycle caused by reversible lithium intercalation and other side reactions with electrolyte.

Silicon has been considered as the next generation anode material for high capacity lithium rechargeable batteries. It has been reported that silicon has the vast theoretical capacity for lithium storage at 4200 mA/g which is over ten times higher than that of conventional carbonaceous material adopted in commercial lithium rechargeable batteries.[3] Significant volume swelling of over 300% upon lithium insertion for silicon anodes has been observed, which further results in electrode mechanical failure through cracking and pulverization during prolonged charging and discharging cycles. [4] In order to take advantage of silicon's vast capacity, efforts to accommodate the volumetric change and to enhance mechanical properties of a silicon-based anode for lithium secondary battery are in urgent need.

Aiming at an improved anode cycle performance, coating the electrode with a film or an interfacial film has been proposed. U.S. Pat. No. 6,733,923 discloses that coating porous metal films on an electrode surface can remarkably improve the capacity of a battery, high rate charging and discharging characteristics and a durability characteristic. U.S. Pat. No. 6,780,541 also discloses that a carbon electrode coated with a porous metal film also improves battery capacities and charging and discharging characteristics.

U.S. Pat. No. 7,078,124 discloses that coating a positive electrode with a polymer layer can increase the degree of the positive active material utilization, the cycle life characteristics and the capacity of the battery can be improved, while swelling of the positive electrode of the lithium-sulfur battery can be reduced.

U.S. Patent Application No. 2012/0183852 discloses a negative electrode comprising a negative active material layer formed on the current collector, and a polymer coating layer that is formed on the negative active material layer and includes a fluorinated acrylate type polymer. The fluorinated acrylate type polymer coating is formed by coating the negative electrode layer comprising fluorinated acrylate type polymer on the negative active material layer with a solution comprising the fluorinated acrylate type monomer and polymerizing the fluorinated acrylate type monomer.

As described in the cited prior art, the coating of a polymer layer is achieved via polymerization of monomers on an electrode active material layer. The polymer coating is beneficial in suppressing electrode swelling so as to improving battery capacity and cycle life. However, the layer formed by polymerization of monomers is merely physically attached on the electrode active material layer, which may dissociate from the active material layer after prolonged charging and discharging cycles, and result in capacity fade and eventual mechanical failure.

Aiming at eliminating the problems found in the prior art electrodes, the inventors have proposed a composite anode having an active material layer and an interfacial film for lithium secondary battery and more particularly, where the interfacial film is chemically bonded to the anode active material layer via a covalent bond. The interfacial film is capable of allowing lithium ions to pass through as well as protect the anode from mechanical failure. This secondary lithium battery also exhibits improved cycle life and battery capacity characteristics.

### SUMMARY OF THE INVENTION

In one embodiment of the present invention, a composite anode comprising an anode active material layer and an interfacial film coated on its surface, said interfacial film is covalently bonded to the anode active material layer.

In another embodiment of the present invention, an anode active material layer comprising anode active materials, inactive materials, and a binder.

In yet another embodiment of the present invention, a method that creates the interfacial film on the silicon composite anode surface.

In still another embodiment of the present invention, a lithium ion secondary battery includes the anode, a cathode, a separator, and an electrolyte.

### BRIEF DESCRIPTION OF THE DRAWINGS

The invention may be more completely understood in consideration of the detailed description of various embodiments of the invention that follows in connection with the accompany drawings, in which:

FIG. 1 shows a sketch of an example anode for a lithium ion battery comprising an anode active material layer comprising silicon particles, carbonaceous materials, a binder; and an interfacial film covering the anode surface.

FIG. 2 shows a graph of the charge and discharge capacities versus cycle number for an example anode.

While the invention is amenable to various modifications and alternative forms, examples thereof have been shown by way of example in the drawing and will be described in detail. It should be understood, however, that the intention is not to limit the invention to the particular embodiments shown and/or described. The intention is to cover all modifications, equivalents, and alternatives falling within the spirit and scope of the invention.

### DETAILED DESCRIPTION OF THE INVENTION

The present invention is believed to be applicable to a variety of different types of lithium secondary batteries and devices and arrangement involving silicon composite electrodes. While the present invention is not necessarily limited, various aspects of the invention may be appreciated through a discussion of examples using the context.

In one embodiment of the present invention, a composite anode, comprising an anode active material layer which is further comprised of at least one active material selected from the group consisting of carbon, silicon, germanium, tin, indium, gallium, aluminum, and boron; and an interfacial film coated on the anode active material layer.

In one embodiment of the present invention, the anode active material layer comprising an anode active material is mixed with carbonaceous materials and a polymer binder. The carbonaceous materials may be obtained from various sources, examples of which may include, but are not limited to, petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The binder may be, but is not limited to, polyvinylidene fluoride, sodium carboxymethyl cellulose, styrene-butadiene rubber, and others well known in the art. The mix comprising the anode active material, carbonaceous materials, and the binder is applied to a current collector. The current collector can be, but is not limited to, a metallic copper film with a preferred thickness of about 10 micrometers to about 100 micrometers.

In one embodiment of the present invention, the interfacial film on the composite anode is a layer of ligands covalently bonded and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, or an aryloxy group. The covalent bond may be formed, without limitation, through a variety of methods, including thermal deposition, electrochemical deposition, photoelectrochemical deposition, and chemical deposition, and other well known methods.

In one embodiment of the present invention, the interfacial film that is covalently bonded to the anode active material layer is a film of polymer made of about 10 to about 10,0000 monomers, with a more preferred composition of about 100 to about 10000 monomers. The monomer includes 1 to about 20 functional groups per monomer molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof. The interfacial film has a thickness of about 0.5 to about 50 micrometers with a more preferred thickness of about 1 to about 10 micrometers. The coating or grafting on the silicon particles may be achieved without limitation through a variety of methods, including thermal deposition, electrochemical deposition, photoelectrochemical deposition, chemical deposition, and other well known methods.

In accordance with another embodiment of the present invention, the interfacial film is created on an anode surface prior the anode being assembled in the lithium secondary battery.

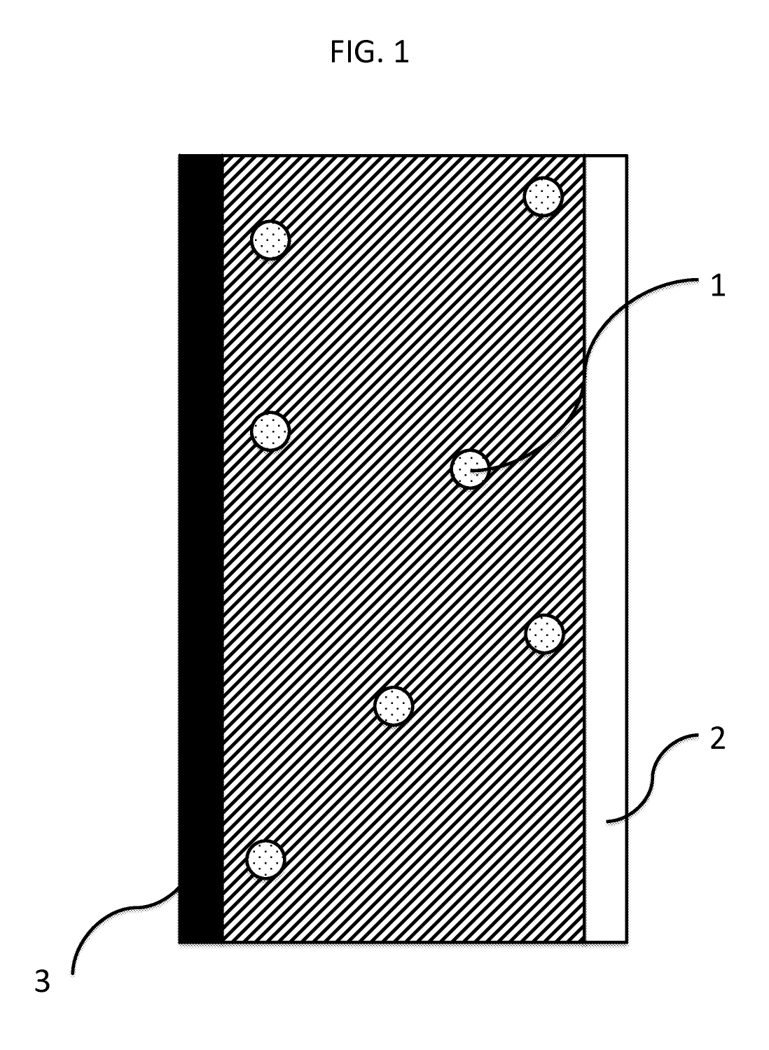

A schematic representation of the anode is shown in FIG. 1, where the composite anode contains anode active material particles 1, and where the composite anode is attached on a current collector 3 which is further covered with an interfacial film 2. The interfacial film is a layer that covers at least about 75% of the silicon composite anode surface with a more preferred coverage of over about 95%. The interfacial film is present in the anode active material in an amount ranging from about 0.001 to about 5 wt. % based on the total weight of the anode active material.

In connection with another embodiment of the present invention, an arrangement for use in a battery is disclosed. The arrangement includes an anode active material mixed with carbonaceous materials and a polymer binder. The carbonaceous materials may be obtained from various sources, examples of which may include, but are not limited to, petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The binder may be, but is not limited to, polyvinylidene fluoride, sodium carboxymethyl cellulose, styrene-butadiene rubber, and other materials known in the art. The mix comprising the anode active material, carbonaceous materials, and the binder can be applied to a current collector. The current collector can be, but is not limited to, a metallic copper film with a preferred thickness of about 10 micrometers to about 100 micrometers. In this fashion, the arrangement can be used as an anode in a lithium secondary battery.

Consistent with one embodiment of the present invention, a lithium secondary battery is implemented with the anode, a cathode, a separator and a non-aqueous electrolyte. The cathode is comprised of active cathode materials, such as lithium manganese, lithium cobalt oxide, lithium ion phosphate compounds, and other materials known in the art.; carbonaceous materials, and a polymer binder. The non-aqueous electrolyte can be a mixture of a lithium compound and an organic carbonate solution. The lithium compound may be, but is not limited to lithium hexafluorophosphate, lithium perchloride, lithium bix(oxatlato)borate, or other compounds known in the art. The separator membrane can be a multiple polymer membrane. The organic solution may be comprised of, but is not limited to, any combination of the following species: ethylene carbonate, dimethyl carbonate, diethyl carbonate, propylene carbonate, vinylene carbonate, or other materials used in the art.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such surface modified silicon particles as the active anode materials for lithium ion batteries.

### Example 1

In this example, 0.5 grams of silicon nanoparticles with an average particle size below about 100 nanometers was well mixed with 0.5 grams of carbon black having an average particle size below about 50 nanometers, 3.5 grams of natural graphite with an average particle size below about 40 micrometers, and 10 milliliters 5 w.t. % polyvinylidene fluoride in n-methylpyrrolidone solution. The resulting mixture was applied to a copper foil via a doctor blade method to deposit a layer of approximately 100 micrometers. The resulting anode active material layer on the copper foil was then dried in vacuum at 120 degree Celsius for 24 hours. The interfacial film was formed by immersing the anode active material layer on the copper foil into a 2.5% n(acetylglycyl)-3-aminopropyltrimethoxysilane in methanol solution for 1 hour. The resulting composite anode was then by rinsed with methanol. and then cured at 120 degree Celsius for 12 hours, and cooled to ambient temperature in vacuum. In this process, covalent silicon oxygen bonds were formed between the active material layer and the interfacial film via hydrosilylation reactions.

### Example 2

In this example, 0.5 grams of silicon nanoparticles with an average particle size below about 100 nanometers were well mixed with 0.5 grams of carbon black having an average particle size below about 50 nanometers, 3.5 grams of natural graphite with an average particle size below about 40 micrometers, and 10 milliliters 5 w.t. % polyvinylidene fluoride in n-methylpyrrolidone solution. The resulting mixture was applied to a copper foil via a doctor blade method to deposit a layer of approximately 100 micrometers. The resulting anode active material layer on the copper foil was then dried in vacuum at 120 degree Celsius for 24 hours. An interfacial film comprising methyl surface groups was created on the anode active material layer via anodic electrografting. Anodic electrografting of methyl groups was performed using the anode active layer on copper foil as a working electrode in methyl magnesium chloride solution (3 M in THF) with a platinum counter and Ag pseudo-reference under quiescent electrode conditions. The electrografting was carried out via potentiostat control at a potential of 0.1 V (vs. Ag/AgCl) for 120 seconds. The composite anode was then thoroughly rinsed with isopropyl alcohol to remove adsorbates followed by drying. In this process, covalent silicon carbon bonds were formed between the active material layer and the interfacial film via electrochemical reactions.

### Example 3

In this example, 0.5 grams of silicon nanoparticles with an average particle size below about 100 nanometers were well mixed with 0.5 grams of carbon black having an average particle size below about 50 nanometers, 3.5 grams of natural graphite with an average particle size below about 40 micrometers, 0.5 grams of carboxymethyl cellulose, and 15 milliliter of de-ionized water. The resulting mixture was applied to a copper foil via a doctor blade method to deposit a layer of approximately 100 micrometers. The resulting anode active material layer on the copper foil was then dried in vacuum at 120 degree Celsius for 24 hours. The interfacial film was formed by immersing the anode active layer in 2.5% n(acetylglycyl)-3-aminopropyltrimethoxysilane in methanol for 1 hour followed by rinsing with methanol. The anodes were then cured at 120 degree Celsius for 12 hours, and cooled to ambient temperature in vacuum. In this process, covalent silicon oxygen bonds were formed between the active material layer and the interfacial film via hydrosilylation reactions.

### Example 4

In this example, 0.5 grams of silicon nanoparticles with an average particle size below about 100 nanometers were well mixed with 0.5 grams of carbon black having an average particle size below about 50 nanometers, 3.5 grams of natural graphite with an average particle size below about 40 micrometers, 0.5 grams of carboxymethyl cellulose, and 15 milliliter of de-ionized water. The resulting mixture was applied to a copper foil via a doctor blade method to deposit a layer of approximately 100 micrometers. The resulting anode active material layer was then dried in vacuum at 120 degree Celsius for 24 hours. An interfacial film comprising methyl surface groups was created on the anode active material layer via anodic electrografting. Anodic electrografting of methyl groups was performed using the anode active layer on copper foil as working electrodes in methyl magnesium chloride solution (3 M in THF) with a platinum counter and Ag pseudo-reference under quiescent electrode conditions. The electrografting was carried out via potentiostat control at a potential of 0.1 V (vs. Ag/AgCl) for 120 seconds. The composite anode was then thoroughly rinsed with isopropyl alcohol to remove adsorbates followed by drying. In this process, covalent silicon carbon bonds were formed between the active material layer and the interfacial film via electrochemical reactions.

The resulting composite anode with the interfacial film is assembled and evaluated as an anode in lithium secondary coin cell CR2032 with lithium metal as the other electrode. A disk of 1.86 cm² was punched from the film as the anode, and the anode active material weight is approximately 5 micrograms. The other electrode was a lithium metal disk with a thickness of 250 micrometers and had the same surface area as the anode. A microporous trilayer polymer membrane was used as separator between the two electrodes. Approximately 1 milliliter 1 molar LiPF₆ in a solvent mix comprising ethylene carbonate and dimethyl carbonate with 1:1 volume ratio was used as the electrolyte in the lithium cell. All of the above experiments were carried out in glove box system under an argon atmosphere with less then 1 part per million water and oxygen.

The assembled lithium coin cell was removed from the glove box and stored in ambient conditions for another 24 hours prior to testing. The coin cell was charged and discharged at a constant current of 0.5 mA, and the charge and discharge rate is approximately C/5 from 0.05 V to 1.5 V versus lithium for over 100 cycles.

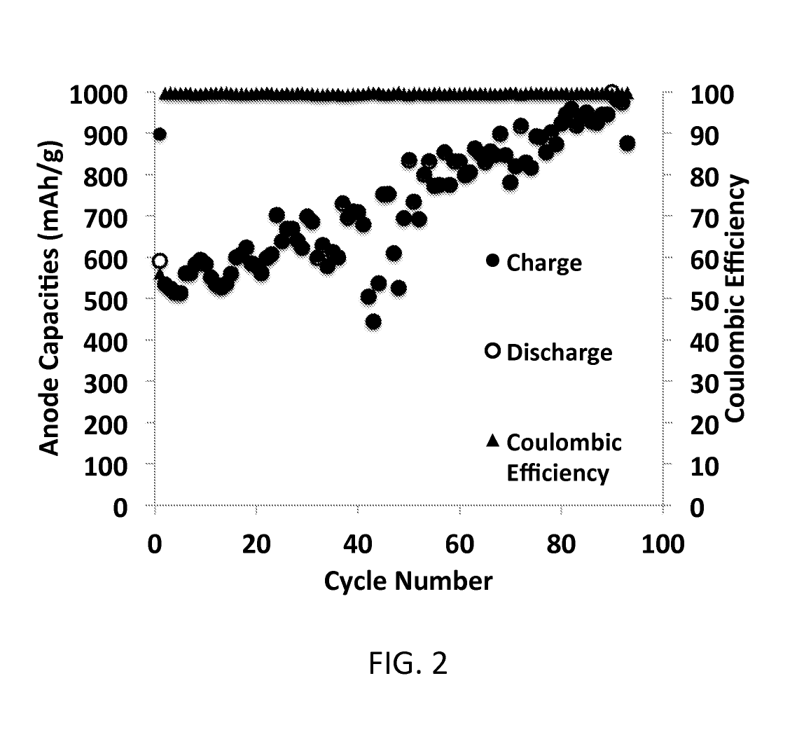

FIG. 2 shows the capacities of the sample anode over 100 charge and discharge cycles. Reversible capacity of over 800 mAh·g⁻¹ can be maintained after over 100 cycles with above 95% depth of discharge.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. For instance, the examples are given for silicon as the anode active material. However other particles may also benefit from this invention. It is the intent of the inventors that variations and equivalents of the invention are with in the scope of the claims below and the description, abstract and drawings are not to be used to limit the scope of the invention.

What the claim is:

1. A composite anode, comprising:
a conductive current collector;
an anode active material layer comprising at least one active material selected from the group consisting of carbon, silicon, germanium, tin, indium, gallium, aluminum, and boron; and
an interfacial film covalently bonded onto the anode active material layer.

2. The composite anode of claim 1, wherein the interfacial film is a layer of polymer and wherein the polymer is made of about 10 to 100,000 monomer molecules.

3. The composite anode of claim 1, wherein the interfacial film has a thickness of about 0.1 to 50 micrometers.

4. The composite anode of claim 1, wherein the interfacial film is formed on the anode active material layer prior to being assembled in a lithium secondary cell.

5. The composite anode of claim 1, wherein the anode active material layer further includes at least one conductive agent selected from the group consisting of carbon black, graphite, carbon fiber, and etc.

6. The composite anode of claim 1, wherein the anode active material layer further includes a polymer binder selected from, polyvinylidene fluoride, sodium carboxymethyl cellulose, styrene-butadiene rubber, or combinations thereof

7. The composite anode of claim 2, wherein the monomer molecules include 1 to about 20 functional groups per molecule and wherein the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof

8. The composite anode of claim 1, wherein the interfacial film is a monolayer that covers at least 75% of a surface of the anode active material layer.

9. The composite anode of claim 1, wherein the interfacial film is covalently bonded to the active anode active material layer by ligand molecules that include 1 to about 20 functional groups per molecule.

10. The composite anode of claim 9, wherein the interfacial film is covalently bonded to the anode activel material layer using electrochemical grafting.

11. The composite anode of claim 9, wherein the interfacial film is covalently bonded to the anode active material layer using a hydrosilation process.

12. The composite anode of claim 9, wherein the functional groups are selected from the group consisting of an amide, an alkoxy, an acetoxy, an acryloxy, an alkyl, an halogenalkyl, an alkylsiloxane, an alkenyl, a carbonyl, an hydroxyl carbonyl, an aryl, an aryloxy, or combinations thereof.
